(19) United States
(12) Patent Application Publication
(10) Pub. No.: US 2025/0080438 A1
(43) Pub. Date: Mar. 6, 2025

(54) DATA PROCESSING METHOD, APPARATUS AND ELECTRONIC DEVICE

(71) Applicant: Beijing Zitiao Network Technology Co., Ltd., Beijing (CN)

(72) Inventors: Yun JI, Beijing (CN); Zhichao YANG, Beijing (CN); Peiyu WEN, Beijing (CN); Jian XU, Beijing (CN)

(21) Appl. No.: 18/821,306

(22) Filed: Aug. 30, 2024

(30) Foreign Application Priority Data
Aug. 30, 2023 (CN) 202311112069.9

(51) Int. Cl. H04L 43/08

(52) U.S. Cl. CPC H04L 43/08

(57) ABSTRACT

A data processing method, an apparatus, and an electronic device are provided. The method includes: acquiring multimedia attribute information and network parameters of real time communication in a period of communication abnormality; acquiring a feature acquisition rule that is preset; determining communication feature information of the real time communication from the multimedia attribute information and the network parameters based on the feature acquisition rule; and determining an abnormality reason of the real time communication in the period of communication abnormality based on the communication feature information.

### CROSS-REFERENCE TO RELATED APPLICATION

The present application claims priority of Chinese Patent Application No. 202311112069.9, filed on Aug. 30, 2023, the disclosure of which is hereby incorporated herein by reference in its entirety as part of the present disclosure.

### TECHNICAL FIELD

Embodiments of the present disclosure relate to the technical field of real time communication (RTC), in particular to a data processing method, an apparatus and an electronic device.

### BACKGROUND

RTC has functions such as voice calls and video calls with high quality and low latency, etc.

Currently, problems such as abnormal audio and visual display may occur during the provision of RTC services to users. Electronic devices may acquire the audio data and video data generated during the RTC process, and process the RTC data by using predefined audio/video assessment algorithms, so as to obtain scores corresponding to the RTC data. If the score is low, the electronic device may determine the presence of communication abnormalities in this RTC service. However, with the above manner, when the electronic device determines the presence of communication abnormalities in RTC services, the reasons for communication abnormalities can only be determined through manual inspection, resulting in low efficiency in identifying the reasons of the communication abnormalities.

### SUMMARY

The present disclosure provides a data processing method, an apparatus, and an electronic device to solve one or more problems in the prior art.

In an aspect, the present disclosure provides a data processing method, and the method comprises:
acquiring multimedia attribute information and network parameters of real time communication in a period of communication abnormality;
acquiring a feature acquisition rule that is preset;
determining communication feature information of the real time communication from the multimedia attribute information and the network parameters based on the feature acquisition rule; and
determining an abnormality reason of the real time communication in the period of communication abnormality based on the communication feature information.

In an aspect, the present disclosure provides a data processing apparatus, and the data processing apparatus comprises a first acquisition module, a second acquisition module, a first determination module, and a second determination module;
the first acquisition module is configured to acquire multimedia attribute information and network parameters of real time communication in a period of communication abnormality;
the second acquisition module is configured to acquire a feature acquisition rule that is preset;
the first determination module is configured to determine communication feature information of the real time communication from the multimedia attribute information and the network parameters based on the feature acquisition rule; and
the second determination module is configured to determine an abnormality reason of the real time communication in the period of communication abnormality based on the communication feature information.

In an aspect, the present disclosure provides an electronic device, which comprises a processor and a memory,
the memory stores computer-executable instructions, and
the processor executes the computer-executable instructions stored in the memory, so as to execute the data processing method according to the above aspects and various possibilities in the above aspects.

In an aspect, the present disclosure provides a non-transitory computer-readable storage medium, computer-executed instructions are stored in the non-transitory computer-readable storage medium, and when the computer-executed instructions are executed by a processor, the data processing method according to the above aspects and various possibilities in the above aspects is implemented.

### BRIEF DESCRIPTION OF DRAWINGS

In order to clearly illustrate the technical solutions of the embodiments of the present disclosure or the existing technology, the drawings of the embodiments or existing technology will be briefly described in the following. It should be understood that the following drawings illustrate some embodiments of the present disclosure, and for ordinary technician in this field, other drawings can be obtained based on these drawings without creative labor.

FIG. 1 is a schematic diagram of an application scenario provided by an embodiment of the present disclosure;

FIG. 2 is a flowchart of a data processing method provided by an embodiment of the present disclosure;

FIG. 3 is a schematic diagram illustrating the composition of communication feature information provided by an embodiment of the present disclosure;

FIG. 4 is a schematic diagram of a network feature provided by an embodiment of the present disclosure;

FIG. 5 is a schematic diagram illustrating the determination of abnormality reason of RTC provided by an embodiment of the present disclosure;

FIG. 6 is a schematic diagram of a method for determining communication feature information provided by an embodiment of the present disclosure;

FIG. 7 is a schematic diagram of a process for determining communication feature information provided by an embodiment of the present disclosure;

FIG. 8 is a schematic structural diagram of a data processing apparatus provided by an embodiment of the present disclosure; and

FIG. 9 is a schematic structural diagram of an electronic device provided by an embodiment of the present disclosure.

### DETAILED DESCRIPTION

The exemplary embodiments will be described in detail below with examples illustrated in the accompanying drawings. When the description below involves the accompanying drawings, unless otherwise indicated, the same number in different drawings represents the same or similar elements. The implementations described in the following exemplary embodiments do not represent all embodiments consistent with the present disclosure. On the contrary, they are only examples of devices and methods consistent with some aspects of the present disclosure as described in the accompanying claims.

In addition, the terms such as “first”, “second”, etc. mentioned in the description, claims, and the accompanying drawings of the embodiments of the present disclosure are only used to distinguish similar objects and are not necessarily used to describe a specific order or sequence. It should be understood that the data used in this way can be interchanged in appropriate cases, so that the embodiments described here can be implemented in order other than the orders illustrated or described here.

In order to facilitate understanding, the concepts involved in the embodiments of the present disclosure are described below.

An electronic device is a device with a wireless transceiver function. The electronic device may be deployed on land, including indoor or outdoor, handheld, wearable, or vehicle-mounted. The electronic device may be a mobile phone, a Pad, a computer with the wireless transceiver function, a virtual reality (VR) electronic device, an augmented reality (AR) electronic device, a wireless terminal in industrial control, a vehicle-mounted electronic device, a wireless terminal in self driving, a wireless electronic device in remote medical, a wireless electronic device in smart grid, a wireless electronic device in transportation safety, a wireless electronic device in smart city, a wireless electronic device in smart home, a wearable electronic device, etc. The electronic device involved in the embodiments of the present disclosure may also be called terminal, user equipment (UE), access electronic device, vehicle-mounted terminal, industrial control terminal, UE unit, UE station, mobile station, remote station, remote electronic device, mobile device, UE electronic device, wireless communication device, UE proxy, or UE device, etc. The electronic device may be fixed or mobile.

In the related art, RTC technology may provide functions with various scenarios such as voice calls, video calls, interactive live broadcast, etc., with high quality and low latency. During the provision of RTC services to users, problems such as abnormal audio and abnormal visual display affect user experience. Therefore, it is needed to quickly and accurately identify the reasons of abnormalities and optimize them. Currently, electronic devices may acquire audio/video data generated during the RTC process and process the RTC data by using predefined audio/video assessment algorithms, so as to obtain scores corresponding to the RTC data. If the score is low, the electronic device may determine the presence of communication abnormalities in the RTC service, and then determine the reasons for abnormalities through manual inspection, resulting in low efficiency in identifying the reasons of communication abnormalities.

In order to solve the technical problems in the related art, the present disclosure provides a data processing method, an apparatus, and an electronic device. The electronic device can acquire multimedia attribute information and network parameters of RTC in the period of communication abnormality, acquire preset feature acquisition rule, determine communication feature information of the RTC from the multimedia attribute information and the network parameters based on the feature acquisition rule, and determine the abnormality reason of the RTC in the period of communication abnormality based on the communication feature information. In the above methods, because the electronic device can automatically determine the communication feature information associated with communication data when communication abnormality occurs in RTC from the multimedia attribute information and the network parameters based on the preset feature acquisition rule, the electronic device can automatically, timely and accurately determine the abnormality reason in RTC based on the communication feature information without manual participation, thus improving the efficiency and accuracy of identifying the reasons of communication abnormalities and improving the user experience.

The embodiments of the present disclosure provide a data processing method. The electronic device can acquire multimedia attribute information and network parameters of RTC in the period of communication abnormality, and acquire preset feature acquisition rule. The electronic device can determine parameter value range corresponding to each type of feature in the feature acquisition rule, and determine communication feature information based on the parameter value range corresponding to each type of feature, the multimedia attribute information, and the network parameters. The electronic device can determine abnormality reason of the RTC in the period of communication abnormality based on the communication feature information. In the above methods, because the electronic device can determine the communication feature information associated with communication data when communication abnormality occurs in RTC, the electronic device can accurately determine the abnormality reason of the RTC based on the communication feature information. Moreover, the electronic device can timely and accurately determine the communication feature information based on the preset feature acquisition rule, thus improving the efficiency and accuracy of identifying the reasons of communication abnormalities and improving the user experience.

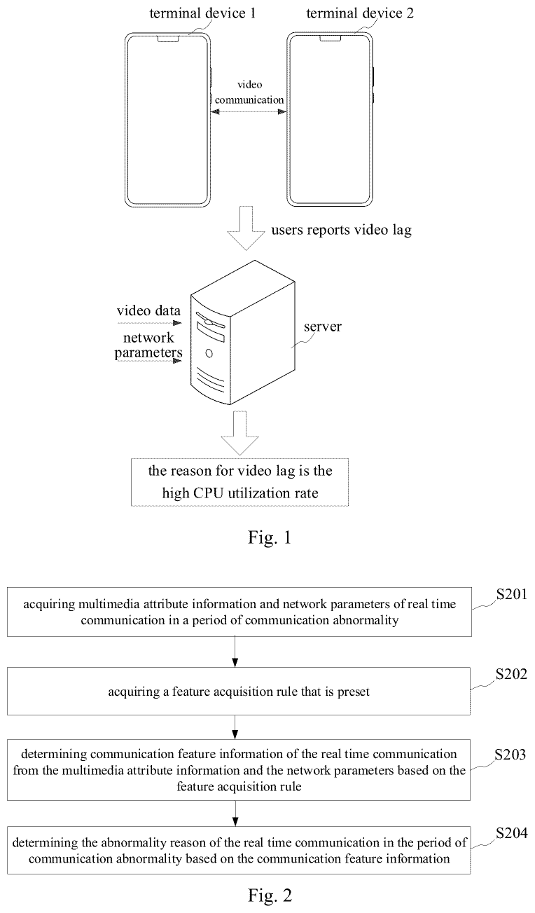

With reference to FIG. 1, an application scenario of the embodiments of the present disclosure is described below.

FIG. 1 is a schematic diagram of an application scenario provided by an embodiment of the present disclosure. Referring to FIG. 1, the application scenario includes a terminal device 1, a terminal device 2, and a server. The terminal device 1 and the terminal device 2 are engaged in video communication. In the process of video communication (including but not limited to the end of the video communication), in response to users reporting video lag, the server may acquire video data and network parameters during the video communication to determine communication feature information of the video communication based on the video data and network parameters. Here, the communication feature information may include central processing unit (CPU) utilization rate being 90%, and the like (which is an illustrative example, in actual application processes, the communication feature information may include various types of information). Based on the communication feature information, the server may determine that the reason for video lag is the high CPU utilization rate. In this way, the server may quickly and accurately determine the abnormality reason, thus improving the efficiency and accuracy of identifying the abnormality reasons.

It should be noted that FIG. 1 is only an exemplary illustration of the application scenario of the embodiments of the present disclosure, and is not a limitation of the application scenario of the embodiments of the present disclosure.

The technical schemes of the present disclosure and how the technical schemes of the present disclosure solve the above technical problems will be described below in detail with specific embodiments. The following specific embodiments may be combined with each other, and the same or similar concepts or processes may not be repeated in some embodiments. The embodiments of the present disclosure are described below with reference to the accompanying drawings.

FIG. 2 is a schematic flowchart of a data processing method provided by an embodiment of the present disclosure. Referring to FIG. 2, the method includes the following steps.

S201, acquiring multimedia attribute information and network parameters of real time communication in a period of communication abnormality.

The execution subject of the embodiments of the present disclosure may be an electronic device or a data processing apparatus arranged in the electronic device. Here, the data processing apparatus may be realized based on software, and the data processing apparatus may also be realized based on the combination of software and hardware, which is not limited by the embodiments of the present disclosure. Alternatively, the electronic device may be any device with on-device computing capability. For example, the electronic device may be a computer, a mobile phone, a server, etc., which is not limited by the embodiments of the present disclosure.

The real time communication may be a low-latency communication technology. For example, the real time communication may be applied to voice calls, video calls, interactive live broadcast, rebroadcasting live streams and other scenarios, to realize communication with high quality and low latency.

It should be noted that the multimedia in the embodiments of the present disclosure may be audio or video, or a combination of both audio and video, which is not limited by the embodiments of the present disclosure.

Alternatively, multimedia data may be generated during the real time communication. For example, in the process of real-time video communication, the electronic device may generate video data (images and audio), and in the process of real-time voice communication, the electronic device may generate voice data (audio).

Alternatively, the period of communication abnormality may be a period in which communication abnormality occurs in RTC. For example, if the RTC experiences an abnormality at time A, the period of communication abnormality may extend from 10 seconds before time A to 10 seconds after time A; if the RTC experiences an abnormality within a time period B, the period of communication abnormality may be the time period B or include the time period B, which is not limited by the embodiments of the present disclosure.

It should be noted that the duration of the period of communication abnormality may be set according to actual requirements, which is not limited by the embodiments of the present disclosure.

Alternatively, the communication abnormality may include audio abnormality, image abnormality, etc. For example, the communication abnormality may include image lag, audio lag, etc. For example, in the process of voice communication, if there is no sound for a period of time, the electronic device may determine that the voice communication experiences an abnormality. In the process of video communication, if there is a period of silence, abnormal sound, no video, or image lag, the electronic device may determine that the video communication experiences an abnormality.

It should be noted that the embodiments of the present disclosure are only exemplary scenarios of communication abnormality, and are not a limitation to the scenarios of communication abnormality.

Alternatively, the electronic device may acquire multimedia attribute information and network parameters of RTC in the period of communication abnormality based on the following feasible implementations: receiving uplink network parameters, uplink multimedia attribute information, downlink network parameters, and downlink multimedia attribute information; determining the period of communication abnormality; and based on the period of communication abnormality, determining the multimedia attribute information and network parameters in the period of communication abnormality from the uplink network parameters, the uplink multimedia attribute information, the downlink network parameters, and the downlink multimedia attribute information.

Alternatively, the uplink network parameters may be network parameters when other devices upload information to this electronic device. For example, the uplink network parameters may be network parameters when other devices upload video data and audio data to this electronic device.

Alternatively, the downlink network parameters may be network parameters when other devices download information from this electronic device. For example, the downlink network parameters may be network parameters when other devices download video data and audio data from this electronic device.

Alternatively, the uplink multimedia attribute information may be attribute information of multimedia data uploaded by other devices to this electronic device. For example, the uplink multimedia attribute information may be attribute information of the media stream released by other devices. For example, the uplink multimedia attribute information may be attribute information of video data or audio data uploaded by other devices to this electronic device.

Alternatively, the downlink multimedia attribute information may be attribute information of multimedia data downloaded by other devices from this electronic device. For example, the downlink multimedia attribute information may be attribute information of the media stream that other devices subscribe to. For example, the downlink multimedia attribute information may be attribute information of video data or audio data downloaded by other devices from this electronic device.

The uplink network parameters may include uplink packet loss rate, round trip time (RTT), available bandwidth at the network transmission level, etc., which is not limited by the embodiments of the present disclosure.

The downlink network parameters may include downlink packet loss rate, RTT, available bandwidth at the network transmission level, etc., which is not limited by the embodiments of the present disclosure.

The uplink multimedia attribute information may include at least one selected from the group consisting of: multimedia capture frame rate, multimedia encoding resolution, and multimedia transmission bitrate.

For example, the capture frame rate of a video stream may be 120 frames per second (fps), that is, when capturing the video stream, 120 images are captured every second; the encoding resolution of the video stream may be 800*800, that is, the resolution of the video stream during playing may be 800*800; the transmission bitrate of the video stream may be 4000 bits per second (bps), that is, the electronic device may transmit a video stream of 1080 P with 60 fps.

The downlink multimedia attribute information may include at least one selected from the group consisting of: multimedia playback frame rate, multimedia caching-related information, duration of lag, and multimedia receiving bitrate.

For example, the playback frame rate of a video stream may be 60 fps, that is, when the video stream is played at a playback terminal, 60 images are played per second; the multimedia caching-related information may include large cache congestion information, small cache congestion information, etc.; the duration of lag may be the duration of video lag or audio lag, which is not limited by the embodiments of the present disclosure; the multimedia receiving bitrate refers to a receiving bitrate when the multimedia receives video streams or audio streams.

Alternatively, the electronic device may determine the period of communication abnormality based on abnormality information fed back by users. For example, in response to a video call experiencing lag, loss of image, or other abnormalities, the user operates the video call device (clicks an abnormality control, etc., which is not limited by the embodiments of the present disclosure), so that the video call device sends abnormality information to the electronic device. The abnormality information may include the time when the abnormality occurs, and the electronic device may determine the period of communication abnormality based on this time. For example, in response to receiving the feedback from the user that the video call experiences an abnormality at time A, the electronic device may determine the time period from 10 minutes prior to time A to 10 minutes after time A as the period of communication abnormality.

For example, at the end of the video call, the user may assign a score to this video call. If the score of the video call is low, the electronic device may determine that the video call experiences an abnormality, and the electronic device may determine the period of the video call as the period of communication abnormality.

It should be noted that the electronic device may determine the period of communication abnormality based on any feasible implementations, which is not limited by the embodiments of the present disclosure.

Alternatively, the electronic device may, based on the period of communication abnormality, determine the multimedia attribute information and network parameters in the period of communication abnormality from the uplink network parameters, the uplink multimedia attribute information, the downlink network parameters, and the downlink multimedia attribute information. For example, while receiving the network parameters and the multimedia attribute information sent by other devices, the electronic device may also receive timestamps corresponding to the network parameters and the multimedia attribute information, so the electronic device can determine the time when the network parameters and the multimedia attribute information appear based on the timestamps. Further, the uplink network parameters, the downlink network parameters, the uplink multimedia attribute information, and the downlink multimedia attribute information within the period of abnormality are determined as the multimedia attribute information and network parameters within the period of communication abnormality. In this way, the electronic device may accurately screen out the multimedia attribute information and network parameters within the period of communication abnormality, thus improving the accuracy of identifying the abnormality reasons.

S202, acquiring a feature acquisition rule that is preset.

The preset feature acquisition rule is used to determine the communication feature information of the RTC from the network parameters and the multimedia attribute information. The communication feature information may include tags of communication features of the RTC. For example, the communication feature information may include the tag for CPU overload, the tag for insufficient sampling frame rates, and the like.

Alternatively, the preset feature acquisition rule may include at least one type of feature selected from the group consisting of: CPU overload feature, capture frame rate feature, network disconnection feature, network switching feature, cache congestion feature, bandwidth feature, packet loss feature, and delay feature.

For example, if the communication feature information of the RTC includes the CPU overload feature, it means that the CPU is overloaded for 10 seconds (or any specified duration) during the period of communication abnormality of the RTC.

For example, if the communication feature information of the RTC includes the capture frame rate feature, it means that the audio or video capture frame rate is low for 10 seconds during the period of communication abnormality of the RTC.

For example, if the communication feature information of the RTC includes the network disconnection feature, it means that physical network disconnection, interactive connectivity establishment (ICE) disconnection, or ICE connection failure occurs for 10 seconds during the period of communication abnormality of the RTC.

For example, if the communication feature information of the RTC includes the network switching feature, it means that the network type or Wi-Fi frequency band changes for 10 seconds during the period of communication abnormality of the RTC.

The cache congestion feature, the bandwidth feature, the packet loss feature, and the delay feature are network feature information in the communication feature information. For example, the network congestion feature may include large cache congestion feature and small cache congestion feature. The bandwidth feature may include low bandwidth feature, medium bandwidth feature, and default normal bandwidth feature. The packet loss feature may include default no packet loss feature, sudden small packet loss feature, sudden large packet loss feature, continuous small packet loss feature, and continuous large packet loss feature. The delay feature may include default low delay feature, medium delay feature, high delay feature, ultra-high delay feature, sudden single-point delay feature, and sudden rising delay feature. In this way, the electronic device can tag the RTC based on various features, thereby improving the accuracy of identifying the abnormality reasons.

It should be noted that degrees such as large, small, low, medium, high, ultra-high and the like in the embodiments of the present disclosure may be determined based on a plurality of preset thresholds. The preset thresholds may be any value, which is not limited by the embodiments of the present disclosure.

Alternatively, the electronic device may acquire the preset feature acquisition rule in a database. For example, a user may pre-write the feature acquisition rule and store the same in a database, and the electronic device may acquire the feature acquisition rule from the database when checking the abnormality reasons of RTC.

It should be noted that the electronic device can acquire the preset feature acquisition rule based on any feasible implementations (for example, the electronic device may receive preset feature acquisition rule sent by other devices), which is not limited by the embodiments of the present disclosure.

S203, determining communication feature information of the real time communication from the multimedia attribute information and the network parameters based on the feature acquisition rule.

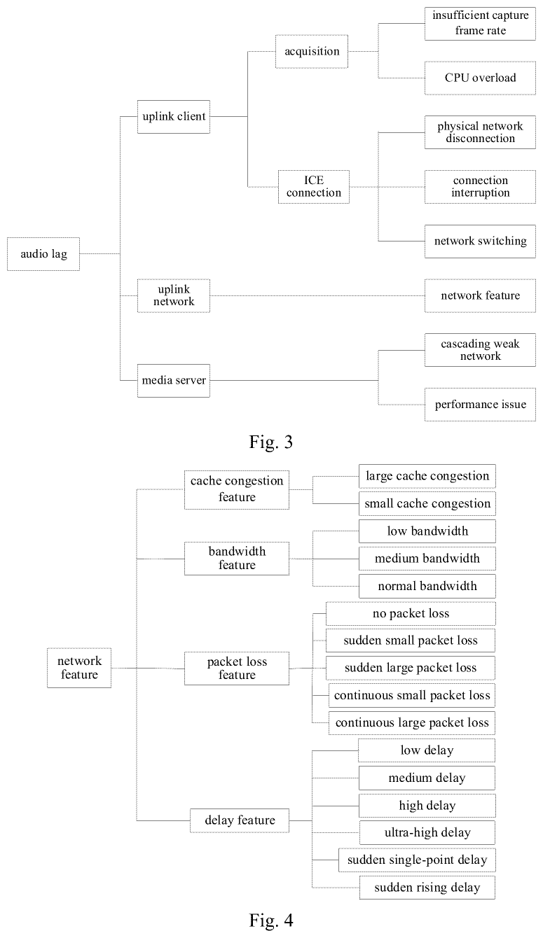

With reference to FIG. 3, the composition of the communication feature information is described below.

FIG. 3 is a schematic diagram illustrating the composition of communication feature information provided by an embodiment of the present disclosure. The embodiment illustrated in FIG. 3 takes audio lag as an example. Referring to FIG. 3, the communication feature information is affected by an uplink client, an uplink network, and a media server during audio lag. The uplink client has the CPU overload feature and the insufficient capture frame rate feature in an audio acquisition scenario, and has the physical network disconnection feature, the connection interruption feature, and the network switching feature in an ICE connection scenario. The uplink network has a network feature during audio lag. The media server has a cascading weak network feature and a performance issue feature during audio lag.

It should be noted that the embodiment shown in FIG. 3 illustrates the features of the uplink client and the uplink network during audio lag, and the downlink client and the downlink network are similar to those, which will not be repeated here.

With reference to FIG. 4, the network features in the embodiment shown in FIG. 3 are further described below.

FIG. 4 is a schematic diagram of a network feature provided by an embodiment of the present disclosure. Referring to FIG. 4, the network feature includes the cache congestion feature, the bandwidth feature, the packet loss feature, and the delay feature which are associated with the network feature. The cache congestion feature may include large cache congestion feature or small cache congestion feature. The bandwidth feature may include low bandwidth feature, medium bandwidth feature, or normal bandwidth feature. The packet loss feature may include no packet loss feature, sudden small packet loss feature, sudden large packet loss feature, continuous small packet loss feature, or continuous large packet loss feature. The delay feature may include low delay feature, medium delay feature, high delay feature, ultra-high delay feature (for example, more than 2 seconds), sudden single-point delay feature, or sudden rising delay feature.

The electronic device may determine the communication feature information of the real time communication from the multimedia attribute information and the network parameters based on the following feasible implementations: determining the parameter value range corresponding to each type of feature in the feature acquisition rule; and determining the communication feature information based on the parameter value range corresponding to each type of feature, the multimedia attribute information, and the network parameters.

Each type of feature has a corresponding parameter value range. If the multimedia attribute information or network parameter corresponding to any type of feature is within the parameter value range corresponding to this feature, the electronic device may determine that this type of feature exists in the real time communication.

For example, the parameter value range of the frame rate feature may be set as less than 85 frames played within 10 seconds, and the electronic device may determine 10 seconds as a time window for feature acquisition. The electronic device may process five pieces of multimedia attribute information (the reporting period of the multimedia attribute information is 2 seconds). If the audio playback frame rate is less than 85 within 10 seconds, the frame rate feature is 1, otherwise the frame rate feature is 0, so that five pieces of multimedia attribute information can be aggregated into one piece of communication feature information. Moreover, the timestamp of the communication feature information is the timestamp of the earliest event (i.e., the first event with a playback frame rate less than 85).

S204, determining the abnormality reason of the real time communication in the period of communication abnormality based on the communication feature information.

Alternatively, the communication feature information may include time sequence information. For example, the electronic device determines the communication feature information of the real time communication based on the multimedia attribute information and the network parameters. Because the multimedia attribute information and the network parameters have time sequence information, the communication feature information may also include time sequence information.

The electronic device may determine the abnormality reason of the real time communication in the period of communication abnormality based on the following feasible implementations: determining a time domain feature associated with the communication feature information based on the time sequence information in the communication feature information; performing Fourier transform on the communication feature information to obtain a frequency domain feature; and determining the abnormality reason of the real time communication in the period of communication abnormality based on the time domain feature and the frequency domain feature.

Alternatively, because the communication feature information may include the time sequence information, the electronic device may process the communication feature information based on a long short-term memory (LSTM) model of a deep neural network, so as to obtain the time domain information associated with the communication feature information.

Alternatively, the electronic device may extract features from the communication feature information based on the time sequence, so as to obtain the time domain feature associated with the communication feature information. For example, the electronic device may calculate the maximum value, minimum value, average value, sum, median, standard deviation, average absolute deviation, quartile difference, etc. on the time sequence, to obtain the time domain feature associated with the communication feature information.

Alternatively, the electronic device may perform Fourier transform on the communication feature information, so as to extract the frequency feature from the Fourier transform result. For example, the electronic device may perform fast Fourier transform on the communication feature information (time sequence data), so as to obtain the frequency domain feature based on the transformed real part and imaginary part.

It should be noted that the electronic device may obtain the time domain feature and the frequency domain feature associated with the communication feature information based on any feasible implementations, which is not limited by the embodiments of the present disclosure.

Alternatively, the electronic device determines the abnormality reason of the real time communication in the period of communication abnormality based on the time domain feature and the frequency domain feature, specifically, in the manner of inputting the time domain feature and the frequency domain feature into a detection model to obtain the abnormality reason of the real time communication.

The detection model is a model obtained by learning a plurality of groups of samples, and each group of samples includes time domain information and frequency domain information of a sample communication feature as well as sample abnormality reason corresponding to the sample communication feature information. For example, the electronic device may acquire time domain information and frequency domain information corresponding to sample communication feature information 1, and determine the sample abnormality reason corresponding to the sample communication feature information 1, so that a group of samples can be obtained, which may include the time domain information and the frequency domain information corresponding to the sample communication feature information 1 as well as the sample abnormality reason. Based on the above method, multiple groups of samples may be obtained.

The detection model may be a decision tree model. For example, the decision tree model may form a tree structure based on multiple decision rules of if sentence and then sentence, and the detection model may put multiple groups of samples at a root node, select an optimal feature (for example, determined based on information gain or information gain ratio), and divide the multiple groups of samples into subsets, so that the training set has the optimal classification under the current conditions. If the multiple subsets can be optimally classified, the detection model may construct leaf nodes; if the multiple subsets cannot be optimally classified, further division is performed on the subsets, and response node is constructed, and recursive process is performed until all samples are correctly classified.

Alternatively, the electronic device may deploy the detection model online in response to completion of the training of the detection model. For example, in the scenario where the abnormality reasons are determined online in real time, the detection model may perform online detection based on a time period of 3 minutes, and for determined room & user (RTC), the detection model may acquire uplink and downlink network parameters and multimedia attribute information of media audio with stream granularity in the last 3 minutes, and cut it into a time window of 10 seconds to extract communication feature information, so as to obtain 18 pieces of communication feature information (1 every 10 seconds, 18 in total over 3 minutes). The electronic device may determine the time domain feature and the frequency domain feature of the communication feature information, and use them as input features of the detection model. After the detection model processes the time domain feature and the frequency domain feature, the abnormality reason of real time communication may be obtained. For example, in an offline scenario, the processing process of the detection model is similar to that in the online scenario. The electronic device may acquire multimedia audio attribute information up to the time point of user feedback, and extract communication feature information with a window of 10 seconds. When processing a sample set of 3 minutes, 18 pieces of communication feature information can be obtained. The electronic device may input the frequency domain feature and the time domain feature of the communication feature information into the detection model, and the detection model may output the abnormality reason of real time communication.

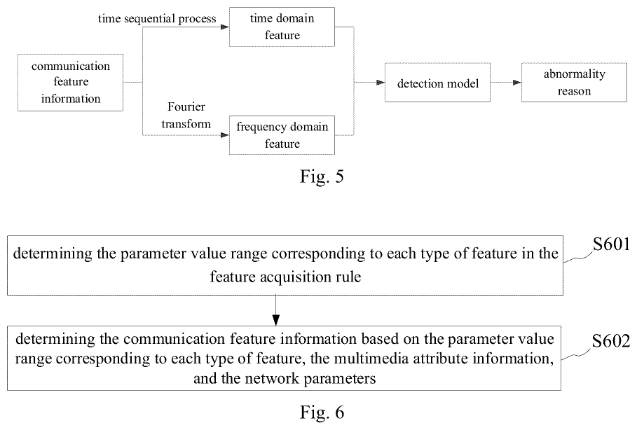

With reference to FIG. 5, the process of determining the abnormality reason of real time communication is described below.

FIG. 5 is a schematic diagram illustrating the determination of abnormality reason of real time communication provided by an embodiment of the present disclosure. Referring to FIG. 5, communication feature information and a detection model are illustrated. The detection model is a model constructed based on a decision tree, and the communication feature information is determined based on the multimedia attribute information and network parameters of real time communication during the period of communication abnormality.

Referring to FIG. 5, the electronic device (not illustrated in FIG. 5) processes the communication feature information in a time sequential manner to obtain a time domain feature associated with the communication feature information, and performs Fourier transform on a frequency domain feature to obtain the frequency domain feature associated with the communication feature information. The electronic device inputs the time domain feature and the frequency domain feature into the detection model, and the detection model may output the abnormality reason of real time communication. In this way, the electronic device may accurately describe the communication feature information based on the frequency domain feature and the time domain feature of the communication feature information, and the electronic device can automatically find the abnormality reason of real time communication in combination with the detection model, so as to improve the efficiency and accuracy of determining the abnormality reasons, thus facilitating rapid processing of abnormalities and enhancing the user experience.

The embodiments of the present disclosure provide a data processing method. The electronic device may acquire multimedia attribute information and network parameters of real time communication in the period of communication abnormality, and acquire preset feature acquisition rule. The electronic device may determine the parameter value range corresponding to each type of feature in the feature acquisition rule, determine communication feature information based on the parameter value range corresponding to each type of feature, the multimedia attribute information, and the network parameters, and determine abnormality reason of the real time communication in the period of communication abnormality based on the communication feature information. In the above method, because the electronic device can determine the communication feature information associated with communication data when communication abnormality occurs in the real time communication, the electronic device can quickly and accurately determine the abnormality reason of the real time communication based on the communication feature information and the detection model, so as to improve the efficiency and accuracy of determining the abnormality reason, thus facilitating rapid processing of abnormalities and enhancing the user experience.

On the basis of the embodiment illustrated in FIG. 2, the method of determining communication feature information of the real time communication from the multimedia attribute information and the network parameters based on the feature acquisition rule in the above data processing method is described below with reference to FIG. 6.

FIG. 6 is a schematic diagram of a method for determining communication feature information provided by an embodiment of the present disclosure. Referring to FIG. 6, the method includes the following steps.

S601, determining the parameter value range corresponding to each type of feature in the feature acquisition rule.

Alternatively, the feature acquisition rule may include multiple types of features and parameter value range corresponding to each type of feature. For example, for the insufficient capture frame rate feature, the parameter value range corresponding to this feature may be set as less than 90 frames within 10 seconds. For the network switching feature, the parameter value range corresponding to this feature may be that network switching or Wi-Fi frequency band change occurs within 10 seconds.

It should be noted that the parameter value range in the embodiments of the present disclosure may be set according to actual requirements, which is not limited by the embodiments of the present disclosure. For example, for the insufficient capture frame rate feature, the value of 10 seconds and the value of frame rate 90 in the parameter value ranges are both adjustable.

It should be noted that when the electronic device acquires the feature acquisition rule, the feature acquisition rule may include multiple parameter value ranges corresponding to multiple types of features.

S602, determining the communication feature information based on the parameter value range corresponding to each type of feature, the multimedia attribute information, and the network parameters.

The electronic device may determine the communication feature information based on the following feasible implementations: for any type of feature, determining multimedia attribute information or network parameters corresponding to this feature; in response to the multimedia attribute information or network parameters corresponding to this feature being within the parameter value range corresponding to this feature, marking this feature as present in the communication feature information; and in response to the multimedia attribute information or network parameters corresponding to this feature being not within the parameter value range corresponding to this feature, marking the feature as absent in the communication feature information.

Each type of feature corresponds to at least one piece of the multimedia attribute information or at least one network parameter. For example, the frame rate feature may correspond to the capture frame rate and playback frame rate in the multimedia attribute information, the packet loss feature may correspond to the packet loss rate in the network parameters, and the delay feature may correspond to RTT in the network parameters.

Alternatively, the electronic device may acquire corresponding relationships between features and the multimedia attribute information and network parameters, and then determine the multimedia attribute information or network parameters corresponding to each type of feature based on the corresponding relationships. For example, the corresponding relationships may be as illustrated in the embodiments shown in FIG. 3 and FIG. 4, and the electronic device may quickly and accurately determine the multimedia attribute information or network parameters corresponding to each type of feature based on the corresponding relationships. For example, for the frame rate feature, the electronic device may acquire the capture frame rate per unit time and the playback frame rate per unit time from the multimedia attribute information based on the frame rate feature and the corresponding relationship illustrated in FIG. 3.

Alternatively, if the multimedia attribute information or network parameter corresponding to the feature is within the parameter value range corresponding to the feature, it indicates that the multimedia attribute information or network parameter matches the feature acquisition rule, and thus the electronic device may mark the feature as present in the communication feature information. For example, the parameter value range of the frame rate feature may be set as less than 90 frames within 10 seconds, so in response to the capture frame rate acquired by the electronic device within 10 seconds being 60 frames, the electronic device may determine that the capture frame rate is within the parameter value range corresponding to the frame rate feature, and then mark the frame rate feature as present (for example, marked as 1) in the communication feature information.

Alternatively, if the multimedia attribute information or network parameter corresponding to the feature is not within the parameter value range corresponding to the feature, it indicates that the multimedia attribute information or network parameter does not match the feature acquisition rule, and thus the electronic device may mark the feature as absent in the communication feature information. For example, the parameter value range of the frame rate feature may be set as less than 90 frames within 10 seconds, so in response to the capture frame rate acquired by the electronic device within 10 seconds being 120 frames, the electronic device may determine that the capture frame rate is not within the parameter value range corresponding to the frame rate feature, and then mark the frame rate feature as absent (for example, marked as 0) in the communication feature information.

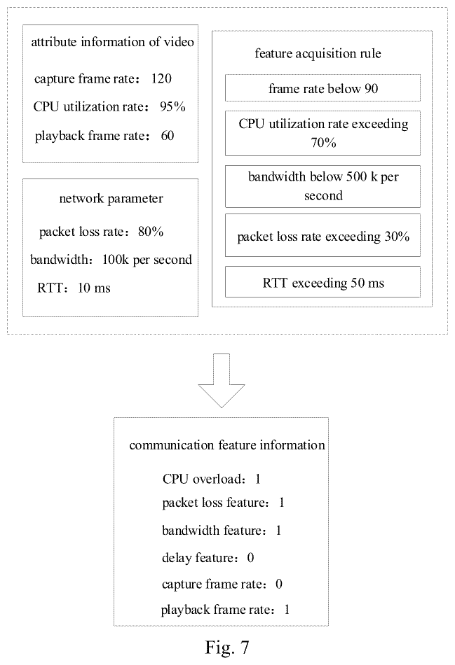

With reference to FIG. 7, the process of determining the communication feature information by the electronic device is described below.

FIG. 7 is a schematic diagram of a process for determining communication feature information provided by an embodiment of the present disclosure. Referring to FIG. 7, the attribute information of video within 10 seconds (exemplary illustration), network parameters within 10 seconds, and the feature extraction rule are illustrated. The attribute information of video may include a capture frame rate of 120, a CPU utilization rate of 95%, and a playback frame rate of 60. The network parameters may include a packet loss rate of 80%, a bandwidth of 100 k per second, and an RTT of 10 ms. The feature acquisition rule may include a frame rate below 90, a CPU utilization rate exceeding 70%, a bandwidth below 500 k per second, a packet loss rate exceeding 30%, and an RTT exceeding 50 ms.

Referring to FIG. 7, the electronic device may determine the communication feature information based on the attribute information of the video, the network parameters, and the feature acquisition rule. The CPU utilization rate in the attribute information of the video is greater than 70%, so the CPU overload in the communication feature information is marked as 1; the capture frame rate in the attribute information of the video is greater than 90 and the playback frame rate is less than 90, so the capture frame rate in the communication feature information is marked as 0 and the playback frame rate is marked as 1; the packet loss rate in the network parameters is greater than 30%, the bandwidth is less than 500 k per second, and the RTT is less than 50 ms, so the packet loss feature in the communication feature information is marked as 1, the bandwidth feature is marked as 1, and the delay feature is marked as 0.

It should be noted that the communication feature information may also include time sequence information, which is not limited by the embodiments of the present disclosure.

In this way, the electronic device may accurately determine the communication feature information corresponding to the real time communication based on the preset feature acquisition rule, the multimedia attribute information, and the network parameters, and then accurately determine the abnormality reason of the real time communication in the period of communication abnormality according to the communication feature information, thus improving the efficiency and accuracy of identifying the abnormality reasons, and processing the abnormalities in time to improve the user experience.

The embodiments of the present disclosure provide a method for determining communication feature information, which includes the following steps: determining the parameter value range corresponding to each type of feature in the feature acquisition rule; for any type of feature, determining multimedia attribute information or network parameters corresponding to the feature; in response to the multimedia attribute information or network parameters corresponding to the feature being within the parameter value range corresponding to the feature, marking the feature as present in the communication feature information; and in response to the multimedia attribute information or network parameters corresponding to the feature being not within the parameter value range corresponding to the feature, marking the feature as absent in the communication feature information. In this way, the electronic device may mark the communication feature information of real time communication in the period of communication abnormality based on the multimedia attribute information and the network parameters in the period of communication abnormality, so as to accurately determine the abnormality reasons, thus improving the efficiency and accuracy of identifying the abnormality reasons.

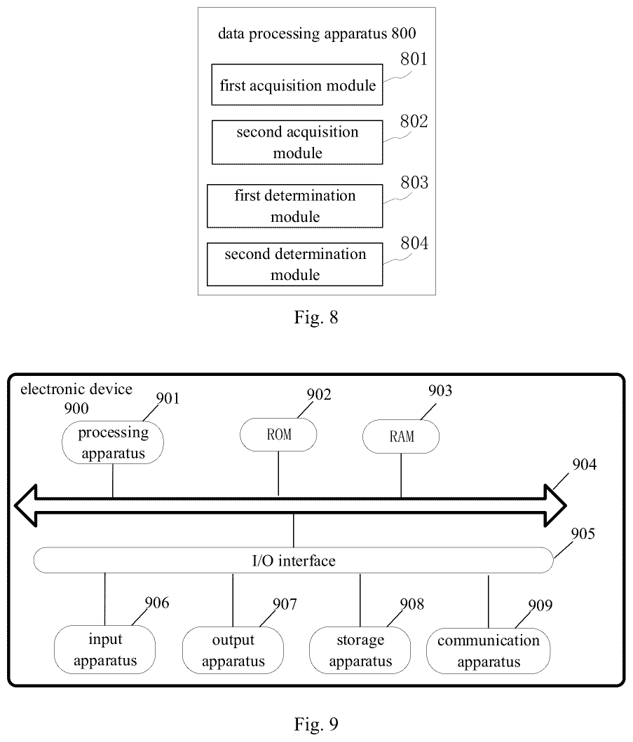

FIG. 8 is a schematic diagram of a data processing apparatus provided by an embodiment of the present disclosure. Referring to FIG. 8, the data processing apparatus 800 includes a first acquisition module 801, a second acquisition module 802, a first determination module 803, and a second determination module 804.

The first acquisition module 801 is configured to acquire multimedia attribute information and network parameters of real time communication in the period of communication abnormality.

The second acquisition module 802 is configured to acquire the feature acquisition rule that is preset.

The first determination module 803 is configured to determine communication feature information of the real time communication from the multimedia attribute information and the network parameters based on the feature acquisition rule.

The second determination module 804 is configured to determine abnormality reason of the real time communication in the period of communication abnormality based on the communication feature information.

According to one or more embodiments of the present disclosure, the first determination module 803 is specifically configured to:
determine the parameter value range corresponding to each type of feature in the feature acquisition rule; and
determine the communication feature information based on the parameter value range corresponding to each type of feature, the multimedia attribute information, and the network parameters.

According to one or more embodiments of the present disclosure, the first determination module 803 is specifically configured to:
for any type of feature, determine multimedia attribute information or network parameters corresponding to the feature;
in response to the multimedia attribute information or network parameters corresponding to the feature being within the parameter value range corresponding to the feature, mark the feature as present in the communication feature information; and
in response to the multimedia attribute information or network parameters corresponding to the feature being not within the parameter value range corresponding to the feature, mark the feature as absent in the communication feature information.

According to one or more embodiments of the present disclosure, the feature acquisition rule includes at least one type of feature selected from the group consisting of: CPU overload feature, capture frame rate feature, network disconnection feature, network switching feature, cache congestion feature, bandwidth feature, packet loss feature, and delay feature.

According to one or more embodiments of the present disclosure, the second determination module 804 is specifically configured to:
determine a time domain feature associated with the communication feature information based on the time sequence information in the communication feature information;
perform Fourier transform on the communication feature information to obtain a frequency domain feature; and
determine the abnormality reason of the real time communication in the period of communication abnormality based on the time domain feature and the frequency domain feature.

According to one or more embodiments of the present disclosure, the second determination module 804 is specifically configured to:
input the time domain feature and the frequency domain feature to a detection model to obtain the abnormality reason of the real time communication,
where the detection model is a model obtained by learning a plurality of groups of samples, and each group of samples include a time domain feature of the sample communication feature information, a frequency domain feature of the sample communication feature information, and sample abnormality reason corresponding to the sample communication feature information.

According to one or more embodiments of the present disclosure, the first acquisition module 801 is specifically configured to:
receive uplink network parameters, uplink multimedia attribute information, downlink network parameters, and downlink multimedia attribute information;
determine the period of communication abnormality; and
based on the period of communication abnormality, determine the multimedia attribute information and network parameters in the period of communication abnormality from the uplink network parameters, the uplink multimedia attribute information, the downlink network parameters, and the downlink multimedia attribute information.

The data processing apparatus provided by the embodiments of the present disclosure can be used to implement the technical scheme of the above-mentioned method embodiments. Its implementation principle and technical effectiveness are similar to those of the method, which will not be repeated here.

FIG. 9 is a schematic structural diagram of an electronic device provided by an embodiment of the present disclosure. Referring to FIG. 9, it illustrates a schematic structural diagram of an electronic device 900 suitable for implementing the embodiments of the present disclosure. The electronic device may include but not be limited to a mobile terminal such as a mobile phone, a laptop, a digital broadcast receiver, a personal digital assistant (PDA), a portable android device (PAD), a portable multimedia player (PMP), a vehicle-mounted terminal (e.g., a vehicle-mounted navigation terminal), etc., and a stationary terminal such as a digital television (TV), a desktop computer, etc. The electronic device 900 illustrated in FIG. 9 is only an example, and should not impose any limitations on the functions and usage scope of the embodiments of the present disclosure.

As illustrated in FIG. 9, the electronic device 900 may include a processing apparatus (e.g., a central processing unit, a graphics processing unit, etc.) 901, which may execute various appropriate actions and processing according to a program stored in a read-only memory (ROM) 902 or a program loaded from a storage apparatus 908 into a random access memory (RAM) 903. The RAM 903 further stores various programs and data required for operation of the electronic device 900. The processing apparatus 901, the ROM 902, and the RAM 903 are connected with each other through a bus 904. An input/output (I/O) interface 905 is also coupled to the bus 904.

Usually, apparatuses below may be coupled to the I/O interface 905: input apparatuses 906 including, for example, a touch screen, a touch pad, a keyboard, a mouse, a camera, a microphone, an accelerometer, a gyroscope, etc.; output apparatuses 907 including, for example, a liquid crystal display (LCD), a speaker, a vibrator, etc.; storage apparatuses 908 including, for example, a magnetic tape, a hard disk, etc.; and a communication apparatus 909. The communication apparatus 909 may allow the electronic device 900 to perform wireless or wired communication with other device to exchange data. Although FIG. 9 illustrates the electronic device 900 including various apparatuses, it should be understood that it is not required to implement or have all the apparatuses illustrated, and the electronic device 900 may alternatively implement or have more or fewer apparatuses.

Specially, according to the embodiments of the present disclosure, the process described above with reference to the flow chart may be implemented as computer software programs. For example, the embodiments of the present disclosure provide a computer program product, which includes a computer program carried on a non-transitory computer readable medium, and the computer program includes program codes for executing the method illustrated in the flow charts. In such embodiments, the computer program may be downloaded and installed from the network via the communication apparatus 909, or installed from the storage apparatus 908, or installed from the ROM 902. When executed by the processing apparatus 901, the computer program may execute the above-described functions defined in the method provided by the embodiments of the present disclosure.

It should be noted that the above-mentioned computer-readable medium in the present disclosure may be a computer-readable signal medium or a computer-readable storage medium or any combination thereof. For example, the computer-readable storage medium may be, but not limited to, electric, magnetic, optical, electromagnetic, infrared, or semiconductor system, apparatus or device, or any combination thereof. Examples of the computer-readable storage medium may include but not limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the method described in the above embodiments.

The embodiments of the present disclosure provide a computer-readable storage medium that stores computer execution instructions. When a processor executes the computer execution instructions, the methods involved by various possibilities of the above embodiments are implemented.

The embodiments of the present disclosure provide a computer program product which comprises a computer program. When executed by a processor, the computer program implements the methods involved by various possibilities of the above embodiments.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquiring unit can also be described as “a unit that obtains at least two Internet protocol addresses”.

The functions described herein above may be performed, at least partially, by one or more hardware logic components. For example, non-restrictively, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but not limited to, electrical, magnetic, optical, electromagnetic, infrared, or semi-conductive system, apparatus or device, or any suitable combination of the foregoing. Examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that the modifications of “a”, “one” and “a plurality of” mentioned in this disclosure are schematic rather than limiting, and those skilled in the art should understand that unless the context clearly indicates otherwise, they should be understood as “one or more”.

The names of the messages or information exchanged between multiple devices in the embodiments of the present disclosure are for illustrative purposes only, and are not intended to limit the scope of these messages or information.

It should be understood that before using the technical solutions disclosed in the embodiments of the disclosure, users should be informed and authorized in an appropriate manner according to relevant laws and regulations regarding the type, scope of use, and usage scenarios of personal information involved in this disclosure.

For example, in response to receiving an active request of a user, a prompt message is sent to the user to clearly remind the user that the operation to be executed as requested by the user will require and use personal information of the user. Thus, according to the prompt information, the user may autonomously choose whether to provide personal information to software or hardware such as an electronic device, an application, a server, or a storage medium that executes the operation of the technical solution of the present disclosure. As an optional but non-restrictive implementation, in response to receiving an active request of a user, a prompt message may be sent to the user through a pop-up window, where a prompt message may be presented in text. In addition, the pop-up window may also carry a selection control for the user to choose whether to “agree” or “disagree” to provide personal information to the electronic device.

It can be understood that the above notification and user authorization process are only illustrative and do not limit the implementation modes of this disclosure. Other modes that comply with relevant laws and regulations can also be applied to the implementation modes of this disclosure.

It can be understood that the data involved in the technical solutions (including but not limited to the data itself, data acquisition or use) should comply with the requirements of corresponding laws, regulations and relevant provisions. The data may include information, parameters, messages, etc., such as stream cutting instruction information.

The above description is only preferred embodiments of the present disclosure and explanation of the technical principles applied. Technicians in this field should understand that the scope of the present disclosure is not limited to the technical solutions formed by specific combinations of the above technical features, and should also cover other technical solutions formed by arbitrary combinations of the above technical features or their equivalent features without departing from the concept of the present disclosure. For example, the technical solution formed by replacing the above features with technical features having similar functions disclosed (but not limited to) in the present disclosure is also in the scope of the present disclosure.

In addition, although multiple operations are described in a specific order, this should not be understood as requiring them to be executed in the illustrated specific order or in sequential order. In certain environments, multitasking and parallel processing may be advantageous. Similarly, although multiple implementation details are included in the above discussion, they should not be interpreted as limiting the scope of this disclosure. Some features described in the context of individual embodiment can also be combined to be implemented in a single embodiment. On the contrary, multiple features described in the context of a single embodiment can also be implemented separately or in any suitable sub-combination in multiple embodiments.

Although the subject matter is described using language specific to structural features and/or method logic actions, it should be understood that the subject matter defined in the appended claims is not necessarily limited to the specific features or actions described above. On the contrary, the specific features and actions described above are merely exemplary forms of implementing the claims.

1. A data processing method, comprising:
acquiring multimedia attribute information and network parameters of real time communication in a period of communication abnormality;
acquiring a feature acquisition rule that is preset;
determining communication feature information of the real time communication from the multimedia attribute information and the network parameters based on the feature acquisition rule; and
determining an abnormality reason of the real time communication in the period of communication abnormality based on the communication feature information.

2. The method according to claim 1, wherein determining the communication feature information of the real time communication from the multimedia attribute information and the network parameters based on the feature acquisition rule comprises:
determining a parameter value range corresponding to each type of feature in the feature acquisition rule; and
determining the communication feature information based on the parameter value range corresponding to each type of feature, the multimedia attribute information, and the network parameters.

3. The method according to claim 2, wherein determining the communication feature information based on the parameter value range corresponding to each type of feature, the multimedia attribute information, and the network parameters, comprises:
for a type of feature, determining the multimedia attribute information or the network parameters corresponding to the feature;
in response to the multimedia attribute information or the network parameters corresponding to the feature being within the parameter value range corresponding to the feature, marking the feature as present in the communication feature information; and
in response to the multimedia attribute information or the network parameters corresponding to the feature being outside the parameter value range corresponding to the feature, marking the feature as absent in the communication feature information.

4. The method according to claim 1, wherein the feature acquisition rule comprises at least one type of feature selected from a group consisting of:
a central processing unit overload feature, a capturing frame rate feature, a network disconnection feature, a network switching feature, a cache congestion feature, a bandwidth feature, a packet loss feature, and a delay feature.

5. The method according to claim 1, wherein the communication feature information comprises time sequence information,
determining the abnormality reason of the real time communication in the period of communication abnormality based on the communication feature information comprises:
determining a time domain feature associated with the communication feature information based on the time sequence information in the communication feature information;
performing Fourier transform on the communication feature information to obtain a frequency domain feature; and
determining the abnormality reason of the real time communication in the period of communication abnormality based on the time domain feature and the frequency domain feature.

6. The method according to claim 5, wherein determining the abnormality reason of the real time communication in the period of communication abnormality based on the time domain feature and the frequency domain feature comprises:
inputting the time domain feature and the frequency domain feature into a detection model to obtain the abnormality reason of the real time communication,
wherein the detection model is a model obtained by learning a plurality of groups of samples, and each group of samples comprises the time domain feature of sample communication feature information, the frequency domain feature of the sample communication feature information, and sample abnormality reason corresponding to the sample communication feature information.

7. The method according to claim 1, wherein acquiring the multimedia attribute information and the network parameters of the real time communication in the period of communication abnormality comprises:
receiving uplink network parameters, uplink multimedia attribute information, downlink network parameters, and downlink multimedia attribute information;
determining the period of communication abnormality; and
based on the period of communication abnormality, determining the multimedia attribute information and the network parameters in the period of communication abnormality from the uplink network parameters, the uplink multimedia attribute information, the downlink network parameters, and the downlink multimedia attribute information.

8. A data processing apparatus, comprising a first acquisition module, a second acquisition module, a first determination module, and a second determination module,
wherein the first acquisition module is configured to acquire multimedia attribute information and network parameters of real time communication in a period of communication abnormality;
the second acquisition module is configured to acquire a feature acquisition rule that is preset;
the first determination module is configured to determine communication feature information of the real time communication from the multimedia attribute information and the network parameters based on the feature acquisition rule; and
the second determination module is configured to determine an abnormality reason of the real time communication in the period of communication abnormality based on the communication feature information.

9. An electronic device, comprising a processor and a memory,
wherein the memory stores computer-executable instructions, and
the processor executes the computer-executable instructions stored in the memory, so as to execute a data processing method,
wherein the method comprises:
acquiring multimedia attribute information and network parameters of real time communication in a period of communication abnormality;
acquiring a feature acquisition rule that is preset;
determining communication feature information of the real time communication from the multimedia attribute information and the network parameters based on the feature acquisition rule; and
determining an abnormality reason of the real time communication in the period of communication abnormality based on the communication feature information.

10. The electronic device according to claim 9, wherein determining the communication feature information of the real time communication from the multimedia attribute information and the network parameters based on the feature acquisition rule comprises:
determining a parameter value range corresponding to each type of feature in the feature acquisition rule; and
determining the communication feature information based on the parameter value range corresponding to each type of feature, the multimedia attribute information, and the network parameters.

11. The electronic device according to claim 10, wherein determining the communication feature information based on the parameter value range corresponding to each type of feature, the multimedia attribute information, and the network parameters, comprises:
for a type of feature, determining the multimedia attribute information or the network parameters corresponding to the feature;
in response to the multimedia attribute information or the network parameters corresponding to the feature being within the parameter value range corresponding to the feature, marking the feature as present in the communication feature information; and
in response to the multimedia attribute information or the network parameters corresponding to the feature being outside the parameter value range corresponding to the feature, marking the feature as absent in the communication feature information.

12. The electronic device according to claim 9, wherein the feature acquisition rule comprises at least one type of feature selected from a group consisting of:
a central processing unit overload feature, a capturing frame rate feature, a network disconnection feature, a network switching feature, a cache congestion feature, a bandwidth feature, a packet loss feature, and a delay feature.

13. The electronic device according to claim 9, wherein the communication feature information comprises time sequence information,
determining the abnormality reason of the real time communication in the period of communication abnormality based on the communication feature information comprises:
determining a time domain feature associated with the communication feature information based on the time sequence information in the communication feature information;
performing Fourier transform on the communication feature information to obtain a frequency domain feature; and
determining the abnormality reason of the real time communication in the period of communication abnormality based on the time domain feature and the frequency domain feature.

14. The electronic device according to claim 13, wherein determining the abnormality reason of the real time communication in the period of communication abnormality based on the time domain feature and the frequency domain feature comprises:
inputting the time domain feature and the frequency domain feature into a detection model to obtain the abnormality reason of the real time communication,
wherein the detection model is a model obtained by learning a plurality of groups of samples, and each group of samples comprises the time domain feature of sample communication feature information, the frequency domain feature of the sample communication feature information, and sample abnormality reason corresponding to the sample communication feature information.

15. The electronic device according to claim 9, wherein acquiring the multimedia attribute information and the network parameters of the real time communication in the period of communication abnormality comprises:
receiving uplink network parameters, uplink multimedia attribute information, downlink network parameters, and downlink multimedia attribute information;
determining the period of communication abnormality; and
based on the period of communication abnormality, determining the multimedia attribute information and the network parameters in the period of communication abnormality from the uplink network parameters, the uplink multimedia attribute information, the downlink network parameters, and the downlink multimedia attribute information.

16. A non-transitory computer-readable storage medium, wherein computer-executed instructions are stored in the non-transitory computer-readable storage medium, and when the computer-executed instructions are executed by a processor, the data processing method according to claim 1 is implemented.

17. The non-transitory computer-readable storage medium according to claim 16, wherein determining the communication feature information of the real time communication from the multimedia attribute information and the network parameters based on the feature acquisition rule comprises:
determining a parameter value range corresponding to each type of feature in the feature acquisition rule; and
determining the communication feature information based on the parameter value range corresponding to each type of feature, the multimedia attribute information, and the network parameters.

18. The non-transitory computer-readable storage medium according to claim 17, wherein determining the communication feature information based on the parameter value range corresponding to each type of feature, the multimedia attribute information, and the network parameters, comprises:
for a type of feature, determining the multimedia attribute information or the network parameters corresponding to the feature;
in response to the multimedia attribute information or the network parameters corresponding to the feature being within the parameter value range corresponding to the feature, marking the feature as present in the communication feature information; and
in response to the multimedia attribute information or the network parameters corresponding to the feature being outside the parameter value range corresponding to the feature, marking the feature as absent in the communication feature information.

19. The non-transitory computer-readable storage medium according to claim 16, wherein the feature acquisition rule comprises at least one type of feature selected from a group consisting of:
a central processing unit overload feature, a capturing frame rate feature, a network disconnection feature, a network switching feature, a cache congestion feature, a bandwidth feature, a packet loss feature, and a delay feature.

20. The non-transitory computer-readable storage medium according to claim 16, wherein the communication feature information comprises time sequence information,
determining the abnormality reason of the real time communication in the period of communication abnormality based on the communication feature information comprises:
determining a time domain feature associated with the communication feature information based on the time sequence information in the communication feature information;
performing Fourier transform on the communication feature information to obtain a frequency domain feature; and
determining the abnormality reason of the real time communication in the period of communication abnormality based on the time domain feature and the frequency domain feature.
